(19) United States
(12) Patent Application Publication
(10) Pub. No.: US 2009/0221243 A1
(43) Pub. Date: Sep. 3, 2009

(54) PORTABLE WIRELESS DEVICE

(75) Inventors: Kiyoshi Egawa, Tokyo (JP); Yoshio Koyanagi, Kanagawa (JP); Hiroshi Haruki, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-Shi, Osaka (JP)

(21) Appl. No.: 11/816,977

(22) PCT Filed: Feb. 21, 2006
(86) PCT No.: PCT/JP2006/302999

§ 371 Date: May 14, 2009

(30) Foreign Application Priority Data
Feb. 24, 2005 (JP) 2005-049361

(51) Int. Cl. H04B 1/38

(52) U.S. Cl. 455/90.3

(57) ABSTRACT

Herein disclosed is a portable wireless device comprising a first monopole antenna section 11 having a length substantially equal to ¾ of a wavelength of a first frequency band, an open sleeve section 12 having a length substantially equal to ¼ of a wavelength of the first frequency band, the open sleeve section 12 being arranged under the condition that the first monopole antenna section 11 and the open sleeve section 12 are parallel to each other, and perpendicular to a line extending through one end of the first monopole antenna section 11 and one end of the open sleeve section 12, a feeding section 13 for feeding a radio frequency signal to the first monopole antenna section 11 and the open sleeve section 12 at the same time, a grounded base plate 14 made of conductive material, and a wireless circuit 15 arranged on the grounded base plate 14. The portable wireless device is useful for an ultra wideband system, and able to reduce the influence from the operator.

### TECHNICAL FIELD OF THE INVENTION

This invention relates to a portable wireless device such as tor example a cellular phone and a mobile wireless device, and more particularly to a wideband antenna of a portable wireless device for performing wireless communication in two or more frequency bands close to each other.

### DESCRIPTION OF THE RELATED ART

As a wideband antenna for a wireless device, there has been known a band sharing dipole antenna and the like.

FIG. 19 is a block diagram showing the construction of the conventional wideband composite antenna device comprising a monopole antenna and an inverted F antenna.

As shown in FIG. 19, the wideband composite antenna device comprises a monopole antenna 61 having a length substantially equal to ½ of a wavelength of a frequency band, an inverted F antenna 62 having a length substantially equal to ½ of a wavelength of the frequency band. The inverted F antenna 62 is disposed in spaced and parallel relationship with a base plate 63, provided with a shorting section 64 at one of its corners and a feeding section 65 distant from the shorting section 64.

In the above-mentioned wideband composite antenna device, the monopole antenna 61 and the inverted F antenna 62 collectively function as a wideband composite polarization antenna under the condition that the monopole antenna 61 is electrically connected to one end of the inverted F antenna 62 on the base plate 63, the feeding section 65 feeding a radio frequency signal to both of the monopole antenna 61 and the inverted F antenna 62 (see patent document 1).

FIG. 20(a) is a front view showing the construction of the multiband dipole antenna, while FIG. 20(b) is a right side view showing the construction of the multiband dipole antenna. The multiband dipole antenna is constituted by elements resonating in respective bands.

In the multiband dipole antenna shown in FIG. 20, the first and second antenna elements 73 and 74 for the first and second frequency bands are arranged on a second base plate 72 located in the close vicinity of the upper part of a base plate 71. The transceiving circuit 75 is arranged on the lower part of the base plate 71, and electrically connected to the first and second antenna elements 73 and 74 through a coaxial cable 78. The bazooka balun 79 arranged on the second base plate 72 includes a first resonating conductor 79A for performing the balanced to unbalanced transformation in the first frequency band and a second resonating conductor 79B for performing the balanced to unbalanced transformation in the second frequency band.

In this multiband dipole antenna, two regions of 800 MHz and 2000 MHz are respectively defined as the first and second frequency bands. The first and second resonant conductors 79A and 79B perform the balanced to unbalance transformation in the respective regions of 800 MHz and 2000 MHz, while the first and second antenna elements 73 and 74 function as respective balanced dipole antennas tor two regions of 800 MHz and 2000 MHz (see patent document 2),

Patent document 1: Jpn. unexamined patent publication No. 2002-64324

Patent document 2: Jpn. unexamined patent publication No. 2003-8330

### DISCLOSURE OF THE INVENTION

### Problems to be Solved by the Invention

In the recent years, we have been received many requests from customers who wishes us to develop an ultra wideband and muitiband antenna having not only two bands of 800 MHz and 2.0 GHz but also an ultra wideband, of 1.7 GHz-2.2 GHz.

We have been further received many requests from customers who wish us to develop an ultra wideband and multiband antenna which can reduce an influence from an operator's body.

The portable wireless device provided with the above-mentioned composite antenna can allow the above-mentioned antenna to function as a wideband balanced antenna by using unbalanced antennas, and reduce the influence from the operator's body. The fractional bandwidth is approximately 7.5%.

On the other hand, the portable wireless device provided with the above-mentioned antenna elements can allow the above-mentioned antenna to function as a balanced antenna by using a bazooka balun 79, and reduce the influence from the operator's body. The first antenna element 73 operates in the region of 800 MHz, while the second antenna element 74 operates in the region of 2200 MHz.

The portable wireless device provided with the above-mentioned antenna elements can be applied to a multiband system in which the second frequency band is twice or so as high as the first frequency band. On the other hand, the first and second antenna elements interfere with each other under the condition that the first and second frequency bands are close to each other.

It is therefore an object of the present invention to provide a portable wireless device that can be applied to an ultra wideband system, and reduce the influence from the operator's body.

### Means for Solving the Problems

The portable wireless device according to the present invention comprises: a first monopole antenna section having a length substantially equal to ¾ of a wavelength of a first frequency band; an open sleeve section having a length substantially equal to ¼ of a wavelength of the first frequency band; a feeding section for feeding a radio frequency signal to the first monopole antenna section and the open sleeve section at the same time; a grounded base plate made of conductive material; and a wireless circuit arranged on the grounded base plate, wherein each of the first monopole antenna section and the open sleeve section has an open end and a feed end through which the radio frequency signal is fed, the first monopole antenna section and the open sleeve section are parallel to each other, and each of the first monopole antenna section and the open sleeve section is perpendicular to a line extending through the feed end of the first monopole antenna section and the feed end of the open sleeve section.

The portable wireless device thus constructed can obtain advantageous effects of having the first monopole antenna section function as a balanced antenna, and reducing influence from the operator's body by reason that the current distribution of the open sleeve section is opposite in phase to the current distribution of the corresponding part of the first monopole antenna section. The portable wireless device can function as a high gain and wideband antenna by reason that the first monopole antenna section has a length substantially equal to ¾ of a wavelength of the first frequency band.

The portable wireless device may further comprise a parasitic element section having a length shorter than ½ of a wavelength of a second frequency band higher than the first frequency band, the parasitic element section being parallel to the first monopole antenna section, and arranged under the condition that the open sleeve section is not in an area between planes defined at respective ends of the parasitic element section, perpendicular to the first monopole antenna section.

In the portable wireless device thus constructed, the parasitic element section can act as a wideband element to the first monopole antenna section, and reduce the influence from the operator's body.

The portable wireless device may further comprise a second monopole antenna section having a length substantially equal to ¾ of a wavelength of a second frequency band higher than the first frequency band, the open sleeve section being arranged between first and second monopole antenna sections, the second monopole antenna section being parallel to each of the first monopole antenna section and the open sleeve section, the open sleeve section being arranged between the first and second monopole antenna sections, the feeding section feeding the radio frequency signal to the first monopole antenna section, the open sleeve section, and the second monopole antenna section at the same time.

The portable wireless device thus constructed can be simple in construction, and function as a high gain and wideband antenna, in addition to advantageous effects of allowing each of the first and second monopole antenna sections to function as a balanced antenna and reducing influence from the operator's body by reason that the current distribution of the open sleeve section is opposite in phase to the current distribution of the corresponding part of the first monopole antenna section in the first frequency band, the current distribution of the open sleeve section is opposite in phase to the current distribution of the corresponding part of the second monopole antenna section in the second frequency band.

The portable wireless device may further comprise a second monopole antenna section having a length substantially equal to ¾ of a wavelength of a second frequency band higher than the first frequency band, the second monopole antenna section being parallel to each of the first monopole antenna section and the open sleeve section, and has a feed end through which the radio frequency signal is fed, the open sleeve section being arranged between first and second monopole antenna sections, and having a node electrically connected to a feed end of the second monopole antenna section, the length between the open end and the node being substantially equal to ¼ of the wavelength of the second frequency band, each of the second monopole antenna section and the open sleeve section being perpendicular to a line extending through the feed end of the second monopole antenna section and the node of the open sleeve section, the feeding section feeding the radio frequency signal to the first monopole antenna section, the open sleeve section, and the second monopole antenna section at the same time.

The portable wireless device thus constructed can be constituted as a wideband and high gain antenna device which is small in size and simple in construction by reason that the position of the maximum value of the current distribution of the first monopole antenna section is in the close vicinity of the position of the maximum value of the current distribution of the open sleeve section.

The portable wireless device may further comprise a third monopole antenna section having a length substantially equal to ¼ of a wavelength of a third frequency band lower than the first and second frequency bands, the third monopole antenna section arranged in the vicinity of the feeding section extending from one end of the grounded base plate under the condition that the third monopole antenna section is parallel to each of the first monopole antenna section and the open sleeve section.

The portable wireless device thus constructed can allow the third monopole antenna section to function as a parasitic element in the third frequency band, and can function as an antenna having a more wide frequency band.

In the portable wireless device according to the present invention, at least one of the first monopole antenna section, the second monopole antenna section, the third monopole antenna section, the open sleeve section, and the parasitic element section may be constituted by a meander shaped element.

The portable wireless device thus constructed can be constituted as an antenna device which is small in size and simple in construction, and which is used in each of the first to third frequency bands.

### ADVANTAGEOUS EFFECT OF THE INVENTION

The portable wireless device according to the present invention can allow the first monopole antenna section to function as a balanced antenna without being affected by the operator's body by reason that the first monopole antenna section has a length substantially equal to ¾ of a wavelength of a first frequency band, the open sleeve section has a length substantially equal to ¼ of a wavelength of the first frequency band, the current distribution of the open sleeve section is opposite in phase to that of the corresponding part of the first monopole antenna section, the first monopole antenna section and the open sleeve section are parallel to each other, and perpendicular to a line extending through the feed end of the first monopole antenna section and the feed end of the open sleeve section.

Further, the portable wireless device according to the present invention can function as a high gain and wideband antenna by reason that the first monopole antenna section has a length substantially equal to ¾ of a wavelength of a first frequency band.

### BRIEF DESCRIPTION OF THE DRAWINGS

FIG. 1 is a block diagram showing the construction of the portable wireless device according to the first embodiment of the present invention.

FIG. 2 is a diagram showing a current distribution of the portable wireless device according to the first embodiment of the present invention.

FIG. 3 is a block diagram showing the construction of the portable wireless device according to the second embodiment of the present invention.

FIG. 4 is a diagram showing a current distribution of the portable wireless device according to the second embodiment of the present invention.

FIG. 5 is a diagram showing impedance characteristic of the portable wireless device according to the second embodiment of the present invention.

FIG. 6 is a block diagram showing the construction of the portable wireless device according to the third embodiment of the present invention.

FIG. 7 is a diagram showing a current distribution of the portable wireless device according to the third embodiment of the present invention.

FIG. 8 is a diagram showing impedance characteristic of the portable wireless device according to toe third embodiment of the present invention.

FIG. 9 is a block diagram showing the construction of the portable wireless device according to the fourth embodiment of the present invention.

FIG. 10 is a diagram showing a current distribution of the portable wireless device according to the fourth embodiment of the present invention.

FIG. 11 is a diagram showing impedance characteristic of the portable wireless device according to the fourth embodiment of the present invention.

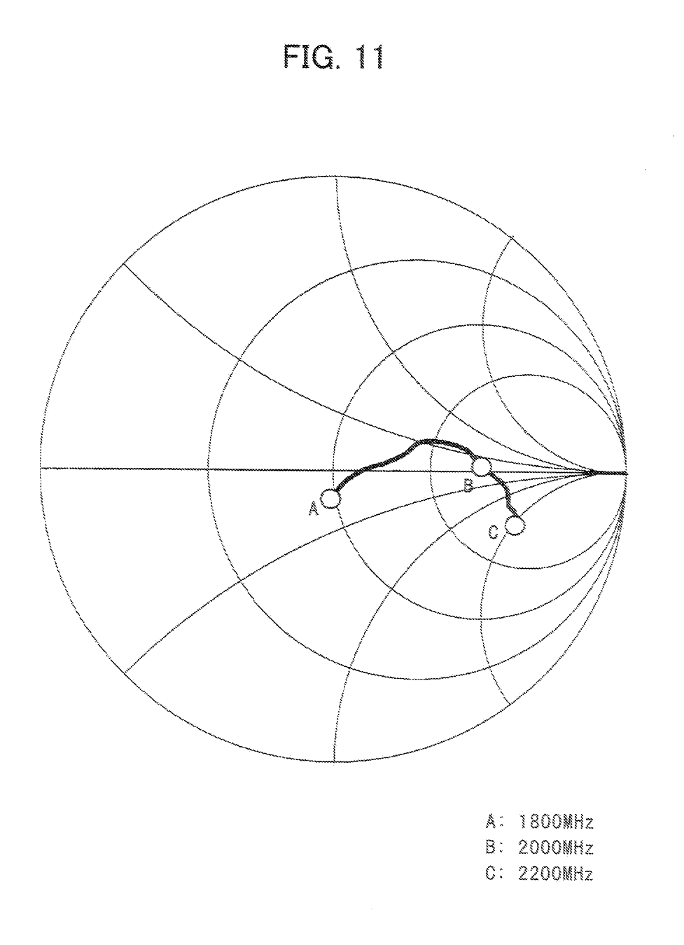

FIG. 12 is a block diagram showing the construction of the portable wireless device according to the fourth embodiment of the present invention, applied as a downsized element.

FIG. 13(a) is a diagram showing a downsized element to which the portable wireless device according to the fourth embodiment of the present invention is applied. FIG. 13(b) is a diagram showing a downsized element to which the portable wireless device according to the fourth embodiment of the present invention is applied. FIG. 13(c) is a diagram showing a downsized element to which the portable wireless device according to the fourth embodiment of the present invention is applied.

FIG. 14 is a diagram showing a radiation characteristic, in the frequency band of 1800 MHz, of the downsized device to which the portable wireless apparatus according to the fourth embodiment of the present invention is applied.

FIG. 15 is a diagram showing a radiation characteristic, in the frequency band of 2000 MHz, of the downsized device to which the portable wireless apparatus according to the fourth embodiment of the present invention is applied.

FIG. 16 is a block diagram showing the construction of the portable wireless device according to the fifth embodiment of the present invention.

FIG. 17 is a diagram showing the construction of the downsized device to which the portable wireless apparatus according to the fifth embodiment of the present invention is applied.

FIG. 18 is a diagram showing a radiation characteristic, in the frequency band of 800 MHz, of the downsized device to which the portable wireless apparatus according to the fifth embodiment of the present invention is applied.

FIG. 19 is a block diagram showing the construction of the conventional wideband composite antenna.

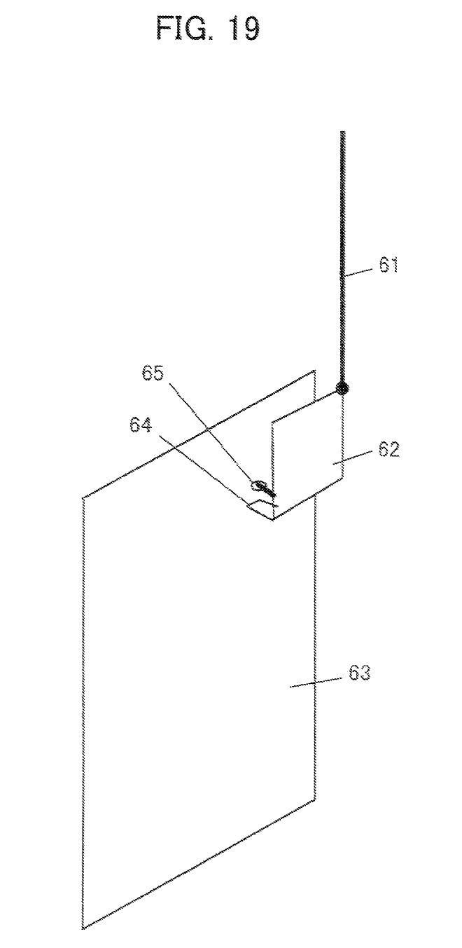

FIG. 20(a) is a front view showing the conventional band sharing dipole antenna. FIG. 20(b) is a right side view showing the conventional band sharing dipole antenna.

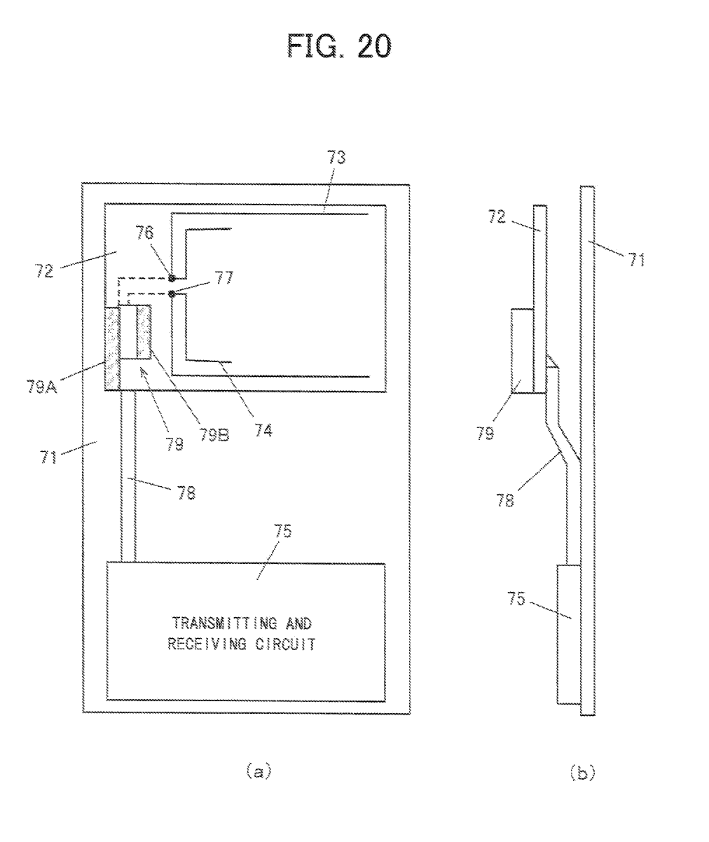

### EXPLANATION OF THE REFERENCE NUMERALS

11: first monopole antenna section

12: open sleeve section

13: feeding section

14: grounded base plate

15: wireless circuit

16: antenna housing

21: parasitic element section

31: second monopole antenna section

32: feeding section

41: second monopole antenna section

42: first meander shaped monopole antenna section

43: meander shaped open sleeve section

44: second meander shaped monopole antenna section

45: downsized element

46a: upper housing

46b: lower housing

51: third monopole antenna section

52: third meander shaped monopole antenna section

61: monopole antenna

62: inverted F antenna

63: base plate

64: short circuit section

65: feeding section

71: base plate

72: second grounded base plate

73: first antenna device

74: second antenna device

75: transceiving circuit

76, 77: feed end

78: coaxial cable

79: bazooka balun (balanced to unbalanced transformer)

79A: first resonant conductor

79B: second resonant conductor

### DESCRIPTION OF THE PREFERRED EMBODIMENTS

The first to fifth embodiments of the portable wireless device according to the present invention will be described hereinafter with reference to accompanying drawings.

### First Embodiment

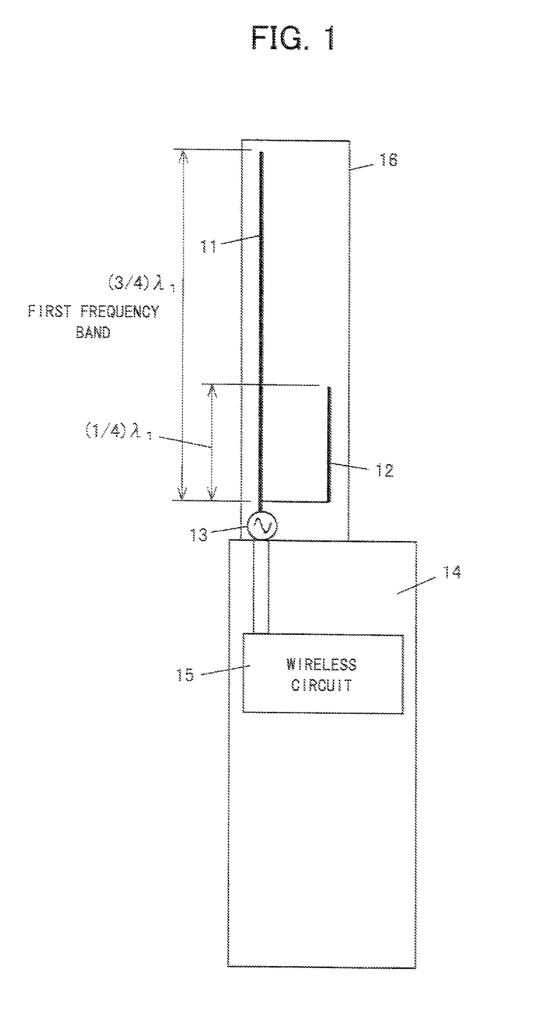

FIG. 1 is a block diagram showing the construction of the portable wireless device according to the first embodiment of the present invention.

As shown in FIG. 1, the portable wireless device according to the first embodiment of the present invention comprises a first monopole antenna section 11 having a length substantially equal to ¾ of a wavelength of a first frequency band, an open sleeve section 12 parallel to the first monopole antenna section 11, and aligned in a longitudinal direction wind respect to the first monopole antenna section 11, the open sleeve section 12 having a length substantially equal to ¼ of a wavelength of the first frequency band, a feeding section 13 for feeding a radio frequency signal to the first monopole antenna section 11 and the open sleeve section 12 at the same time, a grounded base plate 14 made of conductive material, and a wireless circuit 15 arranged on the grounded base plate 14. The first monopole antenna section 11, the open sleeve section 12, and the feeding section 13 are in an antenna housing 16. In this embodiment each of the first monopole antenna section 11 and the open sleeve section 12 has a feed end and an open end. The feeding section 13 feeds the radio frequency signal to each of the first monopole antenna section 11 and the open sleeve section 12 through its feed end. Each of the first monopole antenna section 11 and the open sleeve section 12 is substantially perpendicular to a line extending through the feed end of the first monopole antenna section 11 and the feed end of the open sleeve section 12.

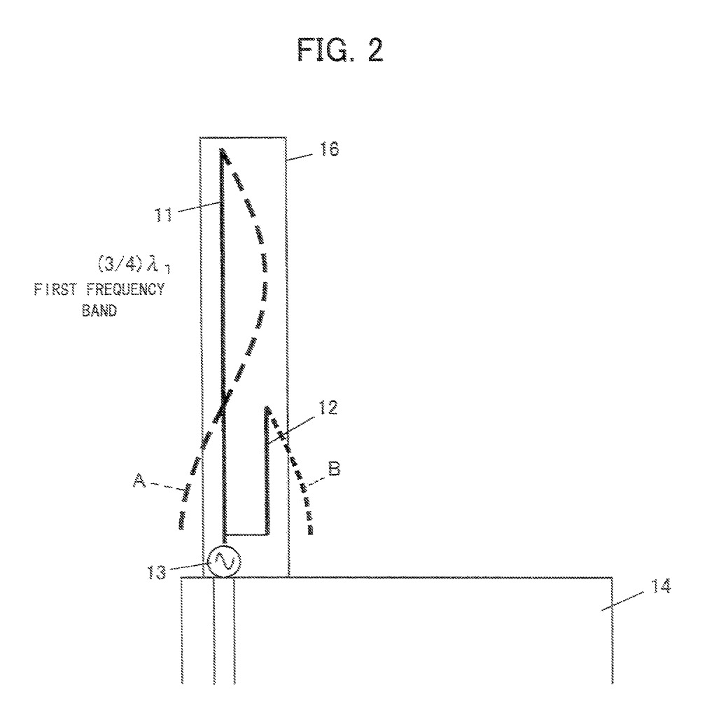

FIG. 2 is a diagram showing a current distribution of each section of the portable wireless device according the first embodiment of the present invention. The current distribution of the first monopole antenna section 11 is indicated by a broken thin line A, while the open sleeve section 12 is indicated by a broken thick line B.

The current distribution of the first monopole antenna section 11 reaches maximum at the feed end of the first monopole antenna section 11, and changes in sign at a point on the first monopole antenna section 11. The length between the point and the open end is substantially equal to ½ of the wavelength of the first frequency band.

On the other hand, the current distribution of the open sleeve section 12 reaches maximum at the feed end distant from the open end on the open sleeve section 12.

As a result of the fact that the current distribution of the open sleeve section 12 is opposite in phase to that of the corresponding part of the first monopole antenna section 11, that part of the first monopole antenna section 11 can not contribute to an emission of the radio wave in the first frequency band. The first monopole antenna section 11 can function as a dipole antenna having a length substantially equal to ½ of a wavelength of the first frequency band by reason that the remaining part of the first monopole antenna section 11 contributes to the emission of the radio wave in the first frequency band.

The portable wireless device according to the present invention can function as high gain and wideband antenna by reason that the first monopole antenna section 11 has a length substantially equal to ¾ of a wavelength of the first frequency band.

### Second Embodiment

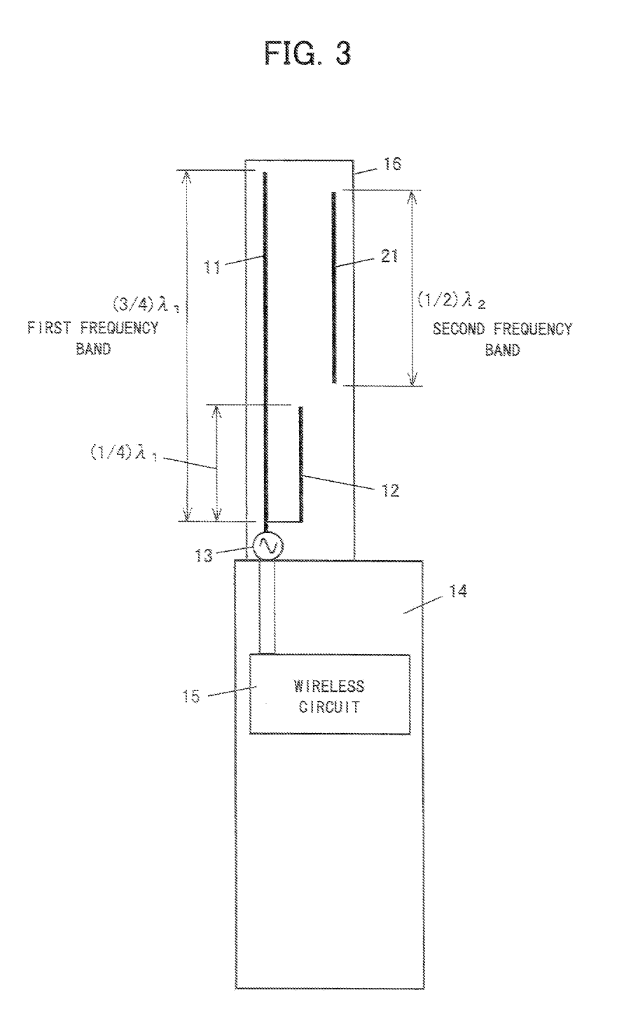

FIG. 3 is a block diagram showing the construction of the portable wireless device according to the second embodiment of the present invention. The elements of the portable wireless device according to the second embodiment the same as those of the portable wireless device according to the first embodiment will not be described but bear the same reference numbers as those of the portable wireless device according to the first embodiment.

As shown in FIG. 3, the portable wireless device according to the second embodiment of the present invention further comprises, in comparison with the portable wireless device according to the first embodiment, a parasitic element section 21 parallel to the first monopole antenna section 11. The parasitic element section 21 has a length substantially equal to ½ of a wavelength of a second frequency band higher than the first frequency band. The open sleeve section 12 is not in an area between planes defined at respective ends of the parasitic element section 21, each of the planes being perpendicular to the first monopole antenna section 11.

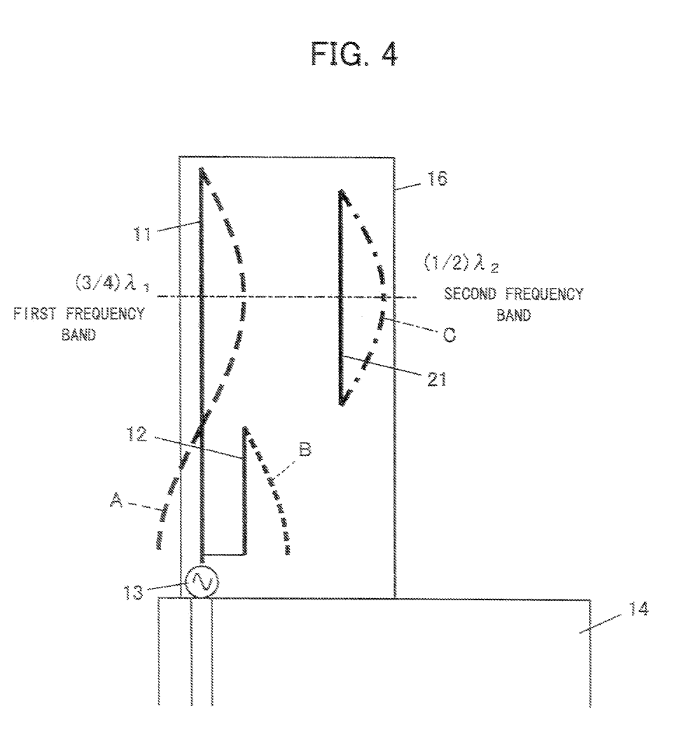

FIG. 4 is a diagram showing a current distribution of the portable wireless device according the second embodiment. The current distribution of the first monopole antenna section 11 is schematically shown by a broken thick line A. The current distribution of the open sleeve section 12 is schematically shown by a broken heavy line B. The current distribution of the parasitic element section 13 is schematically shown by a dashed and dotted line C.

As a result of the fact that the current of the open sleeve section 12 is opposite in phase to that of the corresponding segment of the first monopole antenna section 11 as shown in FIG. 4, the current of the corresponding segment of the first monopole antenna section 11 does not contribute to an emission of radio waves. This means that the first monopole antenna section 11 functions as a dipole antenna having a length substantially equal to ½ of a wavelength of the first frequency band.

The parasitic element section 21 acts as a waveguide to the first monopole antenna section 11 by reason that the parasitic element section 21 is above the open sleeve section 12, close to the first monopole antenna section 11, and has a length substantially equal to ½ of a wavelength of the second frequency band higher than the first frequency band, the position of the maximum value of the current distribution of the parasitic element section 21 being the same as the position of the maximum value of the current distribution of the first monopole antenna section 11.

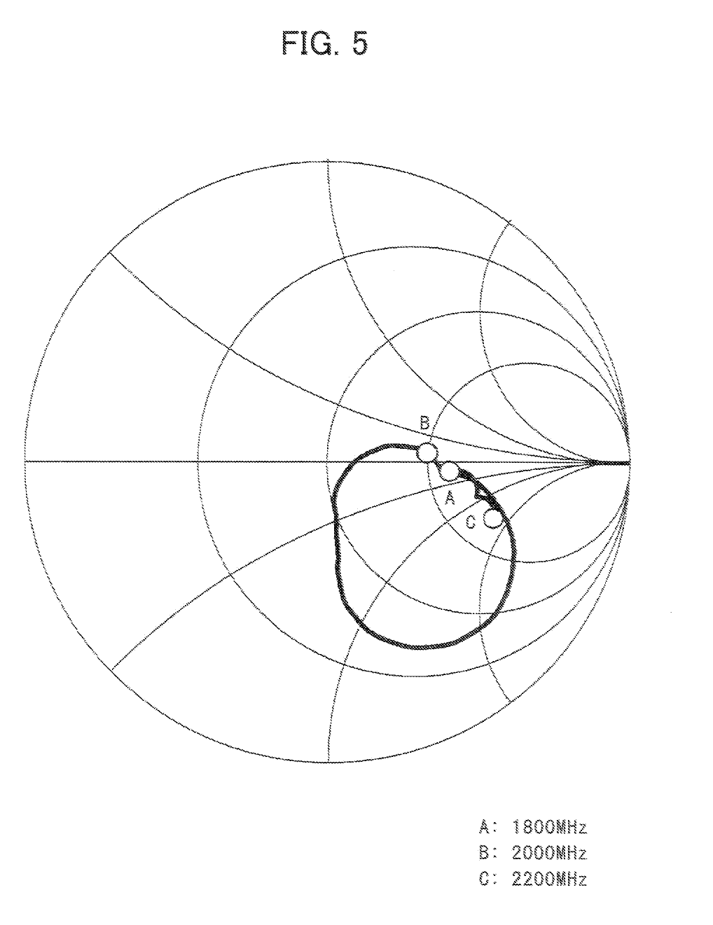

FIG. 5 is a diagram showing impedance characteristic of the portable wireless device according to the second embodiment of the present invention. In FIG. 5, the alphabetic characters “A”, “B”, and “C” correspond to the impedance characteristic at the frequency of 1800 MHz, 2000 MHz, and 2200 MHz.

As shown in FIG. 5, the impedance characteristic at the frequency of 1800 MHz is similar to the impedance characteristic at the frequency of 2200 MHz by reason that the parasitic element section 21 acts as a waveguide to the first monopole antenna section 11. The circular locus of the impedance characteristic shows that the portable wireless apparatus has a wideband characteristic.

The portable wireless device according to the second embodiment of the present invention has advantageous effects of functioning as a wideband antenna, and reducing the influence of the operator's body by reason that the parasitic element section 21 is above the open sleeve section 12, and parallel to the first monopole antenna section 11.

### Third Embodiment

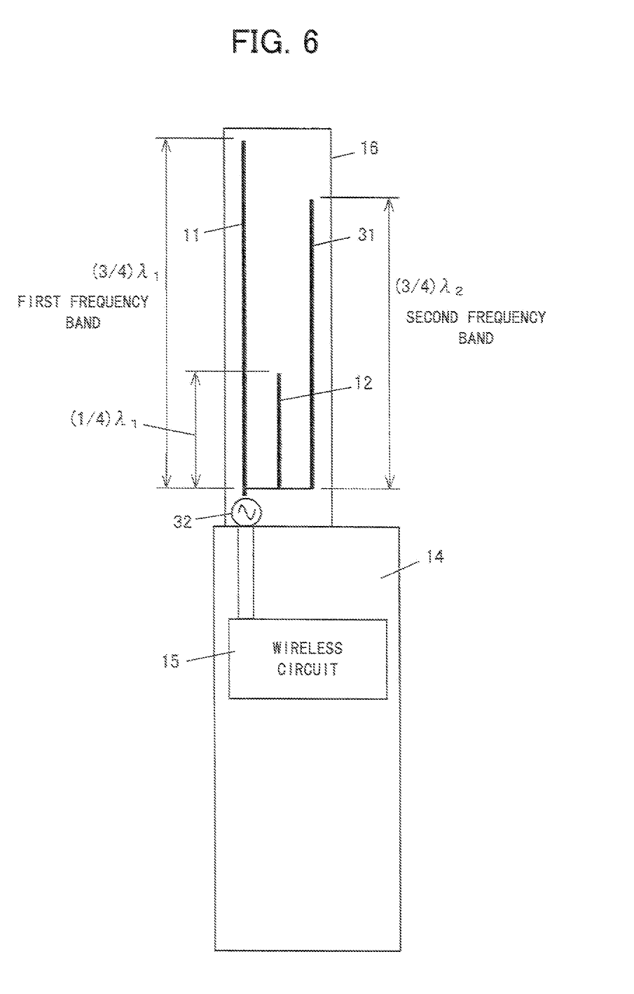

FIG. 6 is a block diagram showing the construction of the portable wireless device according to the third embodiment of the present invention. The elements of the portable wireless device according to the third embodiment the same as those of the portable wireless device according to the first embodiment will not be described but bear the same reference numbers as those of the portable wireless device according to the first embodiment.

As shown in FIG. 6, the portable wireless device according to the third embodiment of the present invention further comprises, in comparison with the first embodiment, a second monopole antenna section 31 having a length substantially equal to ¾ of a wavelength of a second frequency band higher than the first frequency band. The open sleeve section 12 is arranged between the first and second monopole antenna sections. The feeding section 32 feeds a radio frequency signal to the first monopole antenna section 11, the open sleeve section 12, and the second monopole antenna section 31 at the same time. In this embodiment, the second monopole antenna section 31 is parallel to each of the first monopole antenna section 11 and the open sleeve section 12, while the open sleeve section 12 is arranged between the first and second monopole antenna sections 11 and 31.

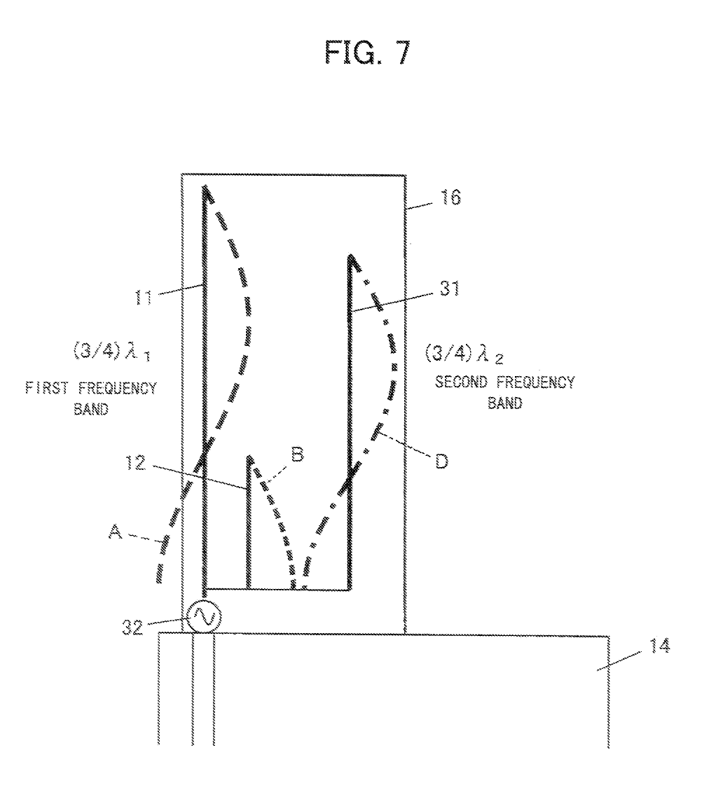

FIG. 7 is a diagram showing a current distribution of the portable wireless device according the third embodiment. The current distribution of the first monopole antenna section 11 is schematically shown by a broken thick line A. The current distribution of the open sleeve section 12 is schematically shown by a broken heavy line B. The current distribution of the second monopole antenna section 31 is schematically shown by a dashed and dotted line D.

As a result of the fact that the current distribution of the open sleeve section 12 is opposite in phase to that of the corresponding part of the first monopole antenna section 11, that part of the first monopole antenna section 11 can not contribute to an emission of the radio wave in the first frequency band as shown in FIG. 7. The first monopole antenna section 11 can function as a dipole antenna having a length substantially equal to ½ of a wavelength of the first frequency band by reason that the remaining part of the first monopole antenna section 11 contributes to the emission of the radio wave in the first frequency band.

As a result of the fact that the current distribution of the open sleeve section 12 is opposite in phase to that of the corresponding part of the second monopole antenna section 31, that part of the first monopole antenna section 31 can not contribute to an emission of the radio wave in the second frequency band. The second monopole antenna section 31 can function as a dipole antenna having a length substantially equal to ½ of a wavelength of the second frequency band by reason that the remaining part of the second monopole antenna section 31 contributes to the emission of the radio wave in the second frequency band.

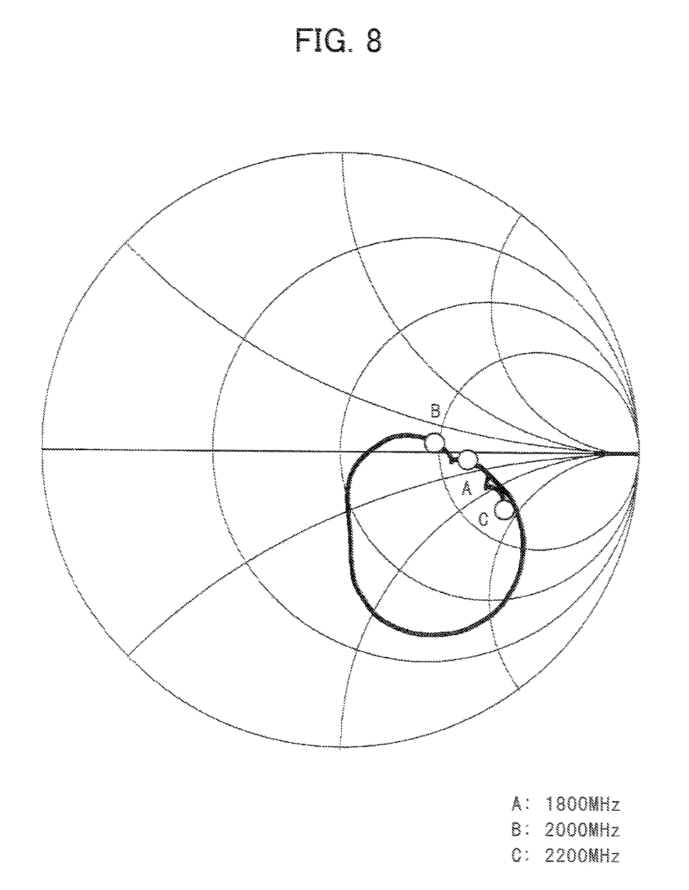

FIG. 8 is a diagram showing impedance characteristic of the portable wireless device according to the third embodiment of the present invention. In FIG. 8, the alphabetic characters “A”, “B”, and “C” correspond to the impedance characteristic at the frequency of 1800 MHz, 2000 MHz, and 2200 MHz.

As will be seen from the impedance characteristic shown in FIG. 5, the impedance characteristic at the frequency of 1800 MHz is similar to the impedance characteristic at the frequency of 2200 MHz. The circular locus of the impedance characteristic shows that the portable wireless apparatus has a wideband characteristic.

The portable wireless device according to the third embodiment of the present invention has advantageous effects of functioning as a wideband antenna, and reducing the influence of the operator's body by reason that the second monopole antenna section 31 has a length substantially equal to ¾ of a wavelength of a second frequency band higher than the first frequency the second monopole antenna section 31 is parallel to each of the first monopole antenna section 11 and the open sleeve section 12, while the open sleeve section 12 is arranged between the first and second monopole antenna sections 11 and 31.

### Fourth Embodiment

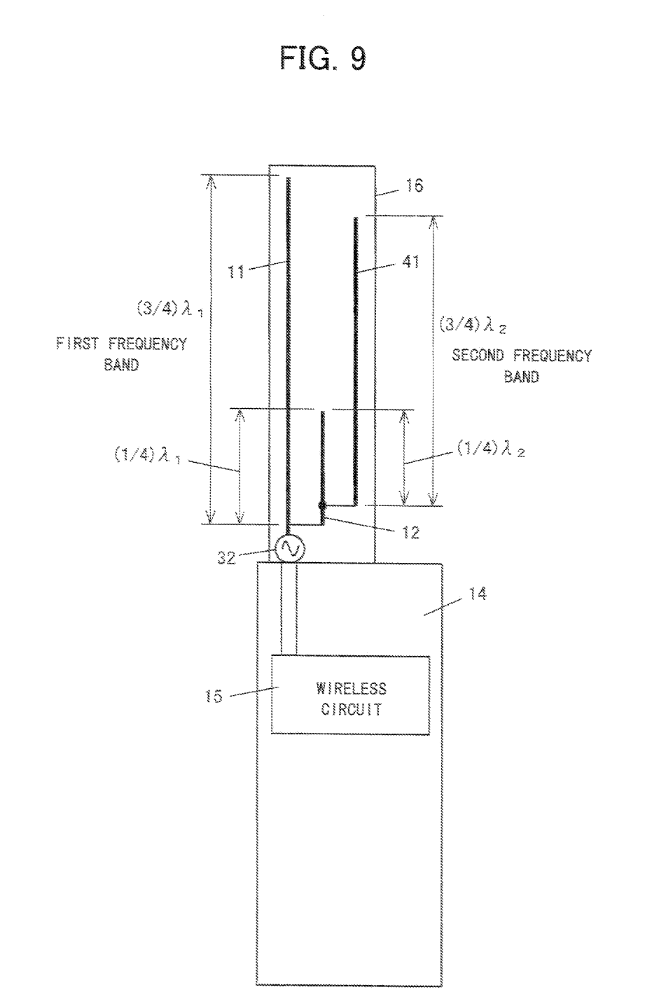

FIG. 9 is a block diagram showing tire construction of the portable wireless device according to the fourth embodiment of the present invention. The elements of the portable wireless device according to the fourth embodiment the same as those of the portable wireless device according to the first embodiment will not be described but bear the same reference numbers as those of the portable wireless device according to the first embodiment.

As shown in FIG. 9, the portable wireless device according to the fourth embodiment of the present invention comprises a second monopole antenna section 41 substantially equal in length to ¾ of a wavelength of a second frequency band, an open sleeve portion 12 having a portion electrically connected to the second monopole antenna section 41, and distant from one end. The open sleeve section 12 is arranged between first and second monopole antenna sections 11 and 41, and has a node electrically connected to a feed end of the second monopole antenna section 41, the length between the open end and the node being substantially equal to ¼ of the wavelength of the second frequency band. Each of the second monopole antenna section 41 and tire open sleeve section 12 is perpendicular to a line extending through the feed end of the second monopole antenna section 41 and the node of the open sleeve section 12. The feeding section 32 feeds the radio frequency signal to the first monopole antenna section 11, the open sleeve section 12, and the second monopole antenna section 41 at the same time.

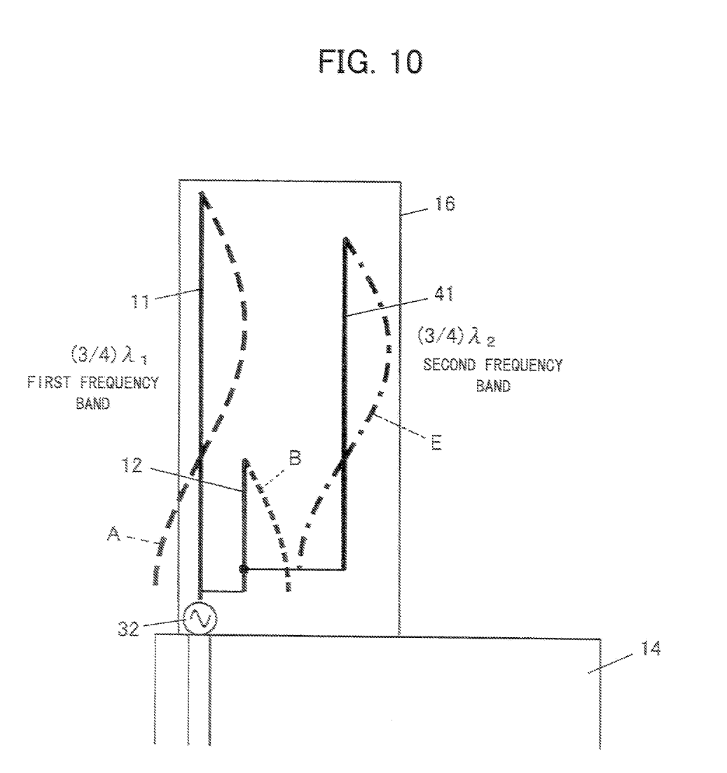

FIG. 10 is a diagram showing a current distribution of the portable wireless device according the fourth embodiment. The current distribution of the first monopole antenna section 11 is schematically shown by a broken thick line A. The current distribution of the open sleeve section 12 is schematically shown by a broken heavy line B. The current distribution of the second monopole antenna section 41 is schematically shown by a dashed and dotted line E.

As shown in FIG. 10, the position of the maximum value of the current distribution of the parasitic element section 21 being similar to the position of the maximum value of the current distribution of the first monopole antenna section 11 by reason that the open sleeve section 12 has a node electrically connected to a feed end of the second monopole antenna section 41, the length between the open end and the node being substantially equal to ¼ of the wavelength of the second frequency band.

When the first and second frequency bands are 1.8 GHz and 2.0 GHz, the length of the first monopole antenna section 11 is 125 mm by reason that the first monopole antenna section 11 has a length substantially equal to ¾ of a wavelength of the first frequency band. The length of the open sleeve section 12 is 41 mm by reason that the open sleeve section 12 has a length substantially equal to ¼ of a wavelength of the first frequency band. The length of the second monopole antenna section 41 is 112 mm by reason that the second monopole antenna section 41 has a length substantially equal to ¾ of a wavelength of the first frequency band. In this embodiment, the distance between the first monopole antenna section 11 and the open sleeve section 12 is 1 mm, while the distance between the second monopole antenna section 41 and the open sleeve section 12 is 1 mm.

In the portable wireless device shown in FIG. 9, the position of the feed end of the second monopole antenna section 41 is distant from the position of the feed end of the open sleeve section 12 by 3.5 mm in an upper direction. The second monopole antenna section 41 is parallel to each of the first monopole antenna section 11 and the open sleeve section 12. The open sleeve section 12 is arranged between the first and second monopole antenna sections 11 and 41.

As shown in FIG. 10, the position of the maximum value of the second monopole antenna section 41 is almost the same as the position of the maximum value of the first monopole antenna section 11. The second monopole antenna section 41 functions as a waveguide in the first frequency band.

From the foregoing description, it will be understood that the portable wireless device according to the fourth embodiment of the present invention can function as a high gain antenna, and reduce the influence of the operator's body.

The following description will be then directed to the case that the portable wireless device according to the present invention is applied to a downsized device.

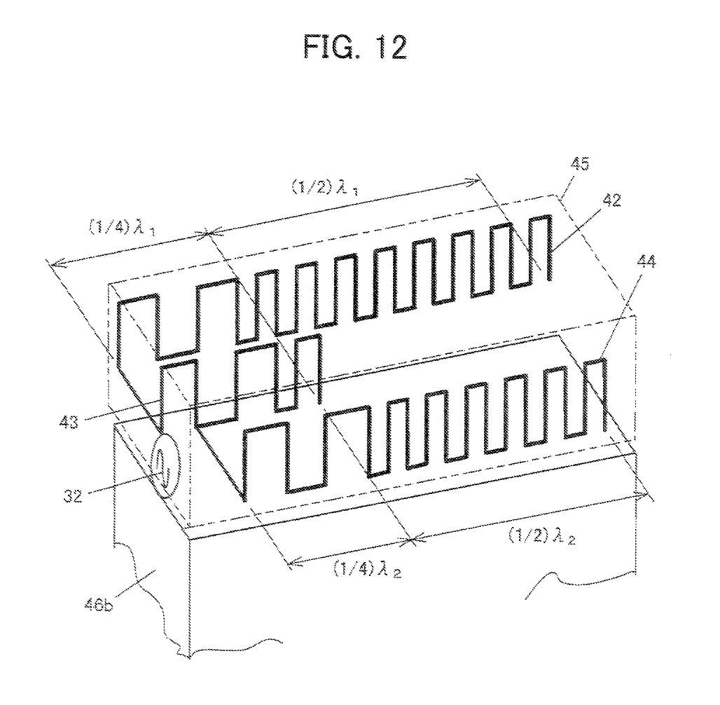

As shown in FIG. 12, the downsized device 45 comprises a first meander shaped monopole antenna section 42 having a length substantially equal to ¾ of a wavelength of the first frequency band, a meander shaped open sleeve section 43, and a second meander shaped monopole antenna section 44 having a length substantially equal to ¾ of a wavelength of the second frequency band. The meander shaped open sleeve section 43 has a nodal point electrically connected to the feed end of the second meander shaped monopole antenna section 44. The length between the nodal point and the open end of the meander shaped open sleeve section 43 is substantially equal to ¼ of a wavelength of the second frequency band. In this embodiment, the meander shaped open sleeve section 43 has a node electrically connected to a feed end of the second meander shaped monopole antenna section 44, the length between the open end and the node being substantially equal to ¼ of the wavelength of the second frequency band. Each of the second meander shaped monopole antenna section 44 and the meander shaped open sleeve section 43 is perpendicular to a line extending through the feed end of the second meander shaped monopole antenna section 44 and the node of the meander shaped open sleeve section 43. The feeding section 32 feeds the radio frequency signal to the first meander shaped monopole antenna section 11, the meander shaped open sleeve section 43, and the second meander shaped monopole antenna section 44 at the same time. The meander shaped open sleeve section 43 is arranged between the first and second meander shaped monopole antenna sections 11 and 44, and parallel to each of the first and second meander shaped monopole antenna sections 11 and 44.

Further, the first meander shaped monopole antenna section 42, the meander shaped open sleeve section 43, and the second meander shaped monopole antenna section 44 are arranged in the downsized device 45.

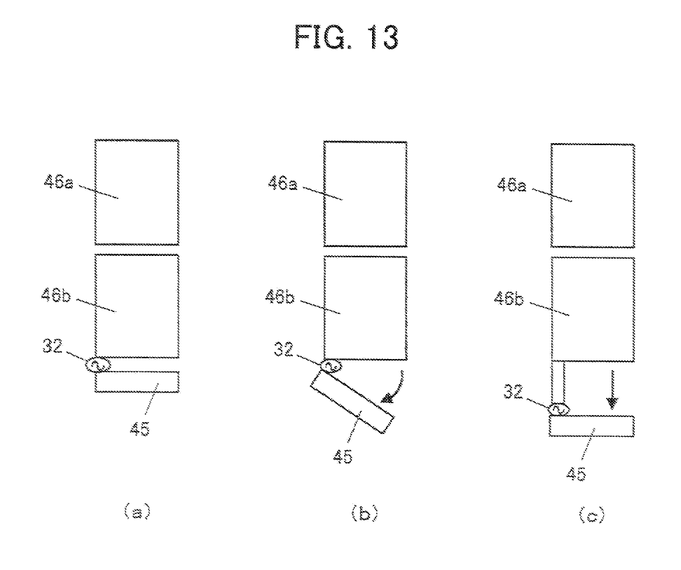

As shown in FIG. 13(a), the housing is constituted by an upper side housing 46a and a lower side housing 46b. The downsized device 45 is arranged at the bottom section of the lower side housing 46b. As shown in FIG. 13(b), the bottom section may be pivotally moved around an axis in the vicinity of the feeding section in a direction of an arrow shown in FIG. 13(b). As shown in FIG. 13(c), the bottom section may be moved in a direction of an arrow shown in FIG. 13(c).

From the foregoing description, it will be understood that the downsized device 45 can reduce the influence from the operator by reason that the first meander shaped monopole antenna section 42 and the meander shaped open sleeve section 43 collectively functio as a dipole antenna having a length substantially equal to ½ of the wave length of the first frequency band, the second meander shaped monopole antenna section 44 and the meander shaped open sleeve section 43 collectively function as a dipole antenna having a length substantially equal to ½ of the wave length of the second frequency band.

When the operator doesn't touch the antenna during a voice call, the antenna characteristic of the portable wireless device can be further improved in the fist and second frequency band.

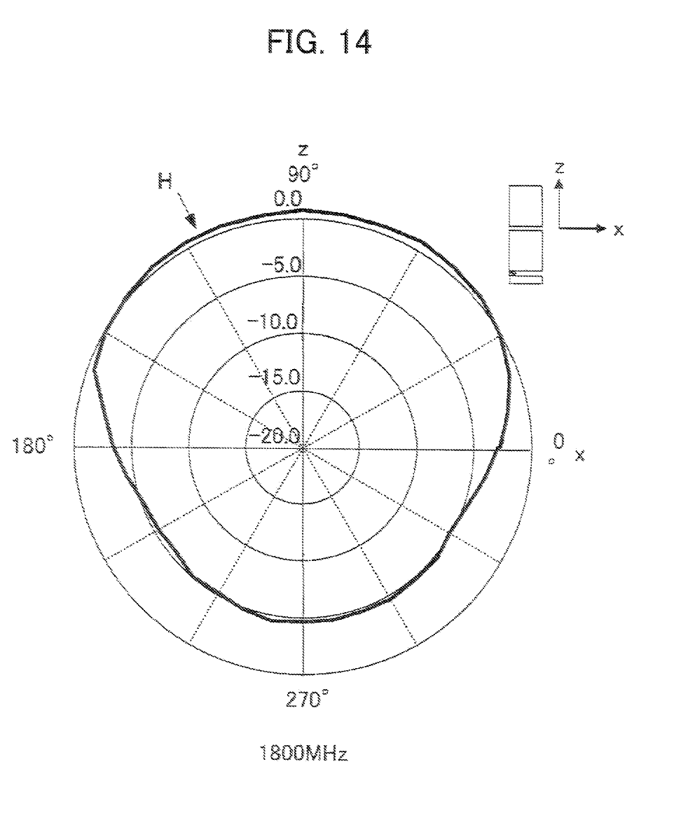

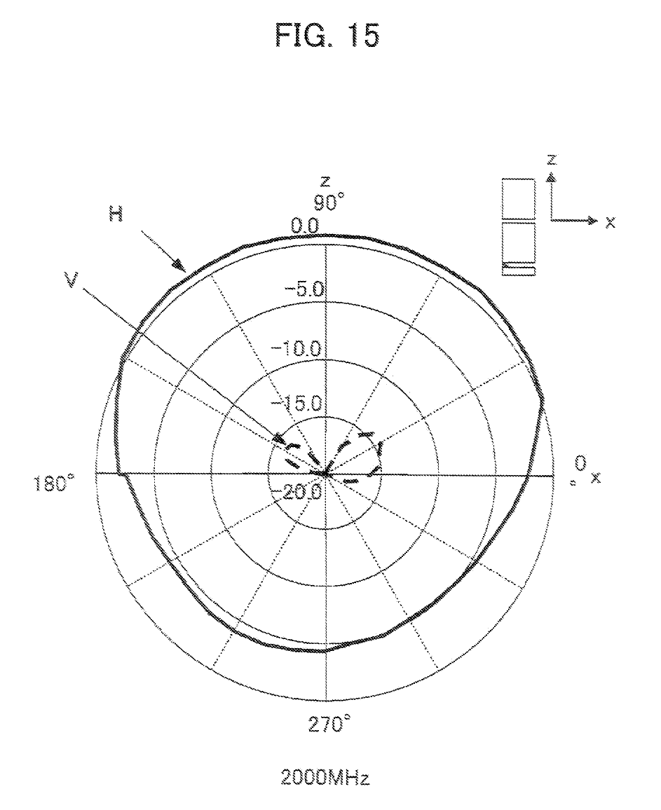

FIG. 14 is a diagram showing a radiation characteristic, in the frequency band of 1800 MHz, of the downsized device to which the portable wireless apparatus according to the fourth embodiment of the present invention is applied. FIG. 15 is a diagram showing a radiation characteristic, in the frequency band of 2000 MHz, of the downsized device to which the portable wireless apparatus according to the fourth embodiment of the present invention is applied. The alphabetic characters “V” and “H” correspond to horizontal and vertical polarized component of the radiation characteristic at the frequency of 1800 MHz and 2000 MHz.

### Fifth Embodiment

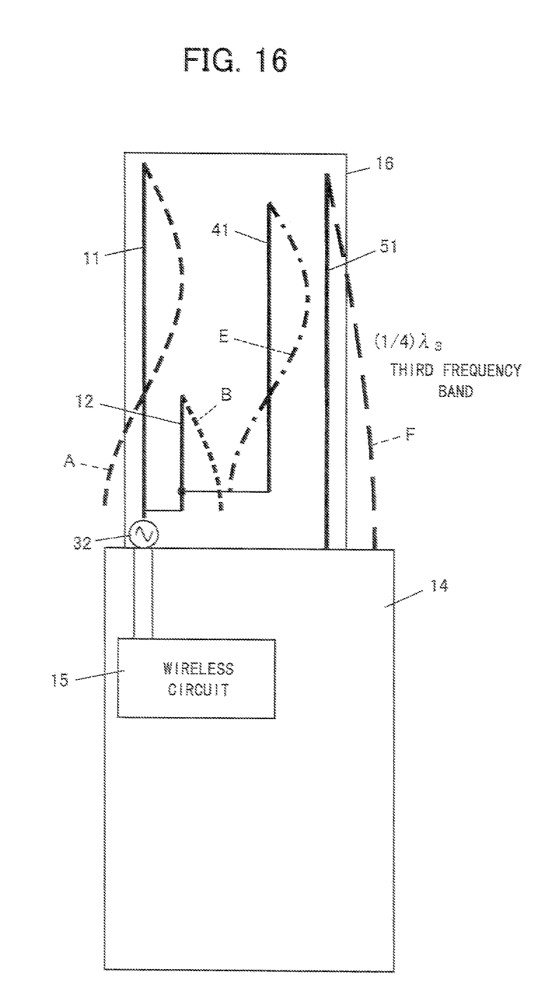

FIG. 16 is a block diagram showing the construction of the portable wireless device according to the fifth embodiment of the present invention. The elements of the portable wireless device according to the fifth embodiment the same as those of the portable wireless device according to the fourth embodiment will not be described but bear the same reference numbers as those of the portable wireless device according to the fourth embodiment.

As shown in FIG. 16, the portable wireless device according to the fifth embodiment of the present invention further comprises, in comparison with the fourth embodiment, a third monopole antenna section 51 parallel to each of the first monopole antenna section 11, the open sleeve section 12, the second monopole antenna section 41. The third monopole antenna section 51 has a length substantially equal to ¼ of a wavelength of a third frequency band lower than the first frequency band.

From the foregoing description, it'll be understood that those sections collectively function as a wideband antenna device by reason that the third monopole antenna section 51 functions as a passive device having a length substantially equal to ¼ of a wavelength of the third frequency band lower than the first and second frequency bands. As shown in FIG. 16, the current distribution of the third monopole antenna section 51 is indicated by a dashed thick line F. The portable wireless device according to the fifth embodiment of the present invention can function as a wideband antenna in a frequency band lower than the first frequency band.

The following description will be then directed to the case that the portable wireless device according the fifth embodiment of the present invention is applied to a downsized element.

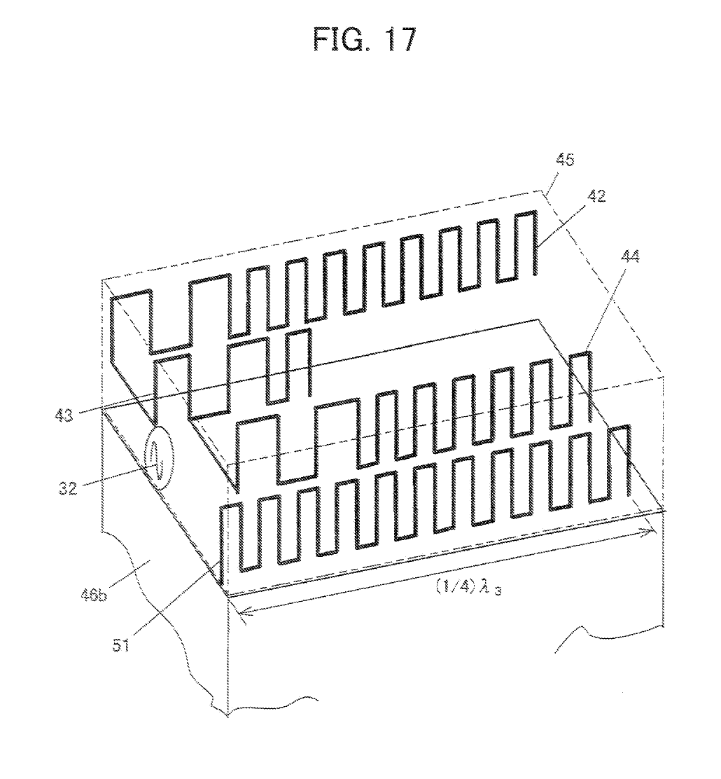

As shown in FIG. 17, the downsized element 45 comprises a third meander shaped monopole antenna section 52 in addition to the first meander shaped monopole antenna section 42, the meander shaped open sleeve section 43, and the second meander shaped monopole antenna section 44.

As shown in FIG. 13(a), the downsized device 45 is arranged at the bottom section of the lower side housing 46b. As shown in FIG. 13(b), the bottom section may be pivotally moved around an axis in the vicinity of the feeding section in a direction of an arrow shown in FIG. 13(b). As shown in FIG. 13(c), the bottom section may be moved in a direction of an arrow shown in FIG. 13(c).

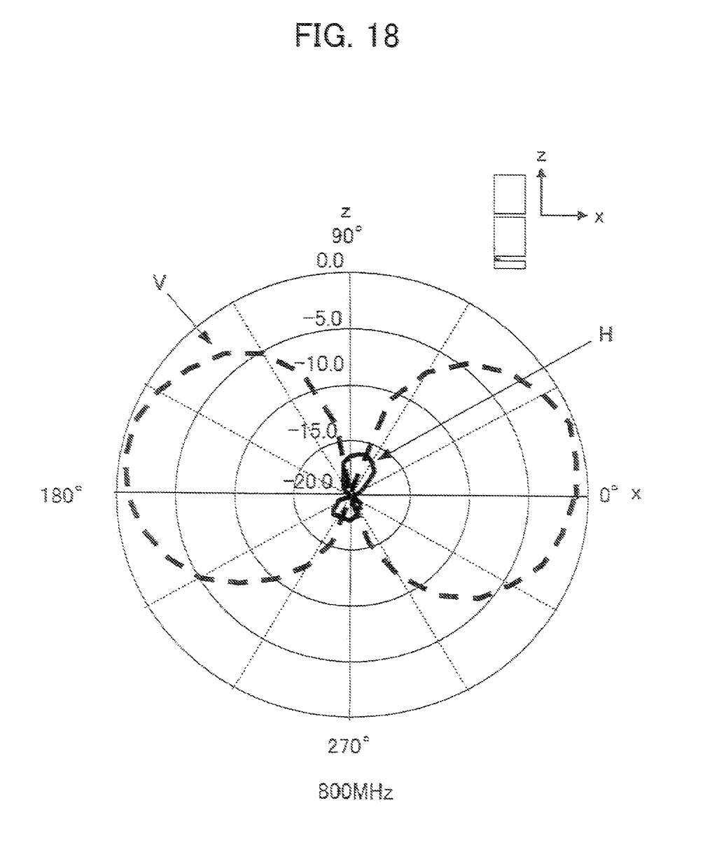

FIG. 18 is a diagram showing a radiation characteristic, in the frequency band of 800 MHz, of the downsized device to which the portable wireless apparatus according to the fourth embodiment of the present invention is applied. The alphabetic characters “V” and “H” correspond to horizontal and vertical polarized component of the radiation characteristic at the frequency of 800 MHz. From the foregoing description, it will he understood that the portable wireless device can function as a wideband antenna in a frequency band of 800 MHz smaller than the first frequency band. When the operator doesn't touch the antenna during a voice call, the antenna characteristic of the portable wireless device can be further improved in the first to third frequency bands.

In this embodiment, each of the distance between the feeding section and the feed end of the first monopole antenna section, the distance between the feeding section and the feed end of the open sleeve section, and the distance between the feeding section and the feed end of the second monopole antenna section is negligibly small in comparison with the length of each section. When each of the distance between the feeding section and the feed end of the first monopole antenna section, the distance between the feeding section and the feed end of the open sleeve section, and the distance between the feeding section and the feed end of the second monopole antenna section is not negligibly small, the distance between the feeding section and the feed end of the first monopole antenna section, the distance between the feeding section and the feed end of the open sleeve section, and the distance between the feeding section and the feed end of the second monopole antenna section may be respectively added to tire first monopole antenna section, the open sleeve section, and the second monopole antenna section.

### INDUSTRIAL APPLICABILITY OF THE PRESENT INVENTION

From the foregoing description, it will be understood that the portable wireless device according to the present invention can be applied to an ultra wideband system, and reduce the influence from the operator's body, and is useful as a portable wireless device provided with antennas corresponding to two or more frequency bands close to each other.

What is claimed is:

1. A portable wireless device, comprising:
a first monopole antenna section having a length substantially equal to ¾ of a wavelength of a first frequency band;
an open sleeve section having a length substantially equal to ¼ of a wavelength of said first frequency band:
a feeding section for feeding a radio frequency signal to said first monopole antenna section and said open sleeve section at the same time;
a grounded base plate made of conductive material; and
a wireless circuit arranged on said grounded base plate, wherein
each of said first monopole antenna section and said open sleeve section has an open end and a feed end through which said radio frequency signal is fed,
said first monopole antenna section and said open sleeve section are parallel to each other, and
each of said first monopole antenna section and said open sleeve section is perpendicular to a line extending through said feed end of said first monopole antenna section and said feed end of said open sleeve section.

2. A portable wireless device as set forth in claim 1, which further comprises a parasitic element section having a length shorter than ½ of a wavelength of a second frequency band higher than said first frequency band, said parasitic element section being in parallel relationship with said first monopole antenna section, and arranged under the condition that said open sleeve section is not in an area between planes defined at respective ends of said parasitic element section, perpendicular to said first monopole antenna section.

3. A portable wireless device as set forth in claim 1, which further comprises a second monopole antenna section having a length substantially equal to ¾ of a wavelength of a second frequency band higher than said first frequency band, in which
said open sleeve section is arranged between first and second monopole antenna sections,
said second monopole antenna section is parallel to each of said first monopole antenna section and said open sleeve section,
said open sleeve section is located between said first and second monopole antenna sections, and
said feeding section feeds said radio frequency signal to said first monopole antenna section, said open sleeve section, and said second monopole antenna section at the same time.

4. A portable wireless device as set forth in claim 1, which further comprises a second monopole antenna section having a length substantially equal to ¾ of a wavelength of a second frequency band higher than said first frequency band, in which
said second monopole antenna section is parallel to each of said first monopole antenna section and said open sleeve section, and has a feed end through which said radio frequency signal is fed,
said open sleeve section is arranged between first and second monopole antenna sections, and has a node electrically connected to a feed end of said second monopole antenna section, the length between said open end and said node being substantially equal to ¼ of said wavelength of said second frequency band,
each of said second monopole antenna section and said open sleeve section is perpendicular to a line extending through said feed end of said second monopole antenna section and said node of said open sleeve section, and
said feeding section feeds said radio frequency signal to said first monopole antenna section, said open sleeve section, and said second monopole antenna section at the same time.

5. A portable wireless device as set forth in claim 3 or claim 4, which further comprises a third monopole antenna section having a length substantially equal to ¼ of a wavelength of a third frequency band lower than said first and second frequency bands, and in which
said third monopole antenna section arranged in the vicinity of said feeding section extends from one end of said grounded base plate under the condition that said third monopole antenna section is parallel to each of said first monopole antenna section and said open sleeve section.

6. A portable wireless device as set forth in claim 5, in which, at least one of said first monopole antenna section, said second monopole antenna section, said third monopole antenna section, said open sleeve section, and said parasitic element section is constituted by a meander shaped element.
